(19) United States
(12) Patent Application Publication
(10) Pub. No.: US 2002/0120926 A1
(43) Pub. Date: Aug. 29, 2002

(54) Apparatus and method for receiving identical broadcasting program

(76) Inventor: Hwa Young Yun, Seoul (KR)

Correspondence Address: BIRCH STEWART KOLASCH & BIRCH, PO BOX 747, FALLS CHURCH, VA, 22040-0747, US

(21) Appl. No.: 09/973,773

(22) Filed: Oct. 11, 2001

(30) Foreign Application Priority Data
Oct. 27, 2000 (KR) 63490/2000

(51) Int. Cl. H04N 7/16

(52) U.S. Cl. 725/22

(57) ABSTRACT

A method for receiving an identical broadcasting program automatically searches broadcasting channels to which an identical broadcasting program corresponding to a program of the channel selected by a user is transmitted from multiplex broadcasting media in case the broadcasting signals are poor or the broadcasting signals have high sound quality or picture quality while the user transmits a broadcasting program through a medium so that the user can watch the identical broadcasting program continuously. In order to achieve this, the present invention searches and outputs a broadcasting program identical to the multiplex broadcasting program from multiplex broadcasting media on the basis of a source ID of the broadcasting program received from broadcasting media.

### BACKGROUND OF THE INVENTION

1. Field of the Invention

The present invention relates to an apparatus and method for receiving an identical broadcasting program and particularly, to an apparatus and method for receiving an identical broadcasting program for receiving broadcasting signals using channel information of multiplex media.

2. Description of the Background Art

Generally, most broadcasting media was a method to receive broadcasting signals using a ground wave. However, currently, the broadcasting media became to receive broadcasting signals using various media such as a satellite, cable and the like as well as the ground wave.

To receive the broadcasting signals outputted through the multiplex media, the user should buy a receiving device for an exclusive use of the media. In case of the conventional receiving device for receiving the ground wave, the user could watch the broadcasting program if the user has a set-top box for an exclusive use of the corresponding media.

The broadcasting outputted through the multiplex media can be on the air by broadcasting a program produced independently, performing mandatory rebroadcasting or contract rebroadcasting a program broadcasted through the ground wave already and broadcasting simultaneously according to the characteristic of the channel. Therefore, the user can watch a program selecting a medium with good transmission status of broadcasting signals and a channel of a medium which broadcasts necessary information.

However, the broadcasting receiving device for an exceptional use of the medium (not shown) or broadcasting receiving device using the set-top box (not shown) cost much and is aesthetically poor since the broadcasting receiving device for an exceptional use of the medium and the broadcasting receiving device using the set-top box should be purchased so as to receive the program transmitted through the multiplex media.

On the other hand, the method for receiving broadcasting signals through the multiplex broadcasting media in accordance with the present invention could receive broadcasting signals through the multiplex media. However, the broadcasting program displayed to the user through a displaying apparatus (not shown) outputted just one channel among various channels of the multiplex broadcasting media and was similar to a method of receiving broadcasting signals from the conventional single broadcasting media. Namely, the user could watch broadcasting-programs by pushing a corresponding channel after selecting the media in which the preferable program was broadcasted through a remote controller and accordingly, there was a disadvantage that the broadcasting signals are not transmitted by a certain reason while the user watches the broadcasting program through a random medium and the user should push channels many times to receive an identical broadcasting program through the media which transmitted broadcasting signals of high picture and sound quality.

As described above, conventionally, since there were several tens of channels broadcasted through a broadcasting medium, it cost much time for the user to search a necessary broadcasting program. Also, in case the broadcasting signals are not transmitted by a certain reason or the user wants to receive an identical broadcasting program through the media which transmitted broadcasting signals of high picture and sound quality while the user watches the broadcasting program through a random medium, the number of channels according to digital broadcasting increases to several tens to hundreds and accordingly, it took much time to search whether there is an identical program as the broadcasting program which the user watches at present in another broadcasting media.

### SUMMARY OF THE INVENTION

Therefore, an object of the present invention is to provide an apparatus and method for receiving an identical broadcasting program for searching an identical broadcasting program through media which transmit broadcasting signals automatically in case the broadcasting signals are not transmitted by a certain reason or a user wants to receive an identical broadcasting program through the media which transmit broadcasting signals with high picture and sound quality while the user watches the broadcasting program through a random medium so that the user can watch the identical broadcasting program continuously.

To achieve these and other advantages and in accordance with the purpose of the present invention, as embodied and broadly described herein, there is provided a method for receiving an identical broadcasting program in accordance with the present invention, comprising the steps of reading a source ID of a broadcasting program transmitted from broadcasting media, searching whether the broadcasting program having an identical source ID as the source ID is on the air from multiplex media and selecting whether the media would be converted or not by reporting the searching result to the user.

There is also provided an apparatus for receiving an identical broadcasting program in accordance with the present invention in an apparatus for outputting an image signal or voice signal by receiving broadcasting signal through multiplex broadcasting media, comprising an identical broadcasting program searching unit for searching a channel to which a same broadcasting program as a program of a channel selected by a user and a channel selection unit for selecting a broadcasting signal corresponding to the searched channel.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing the composition of an apparatus for receiving an identical broadcasting program in accordance with the present invention; and

FIG. 2 is a flow chart showing a method for receiving an identical broadcasting program in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

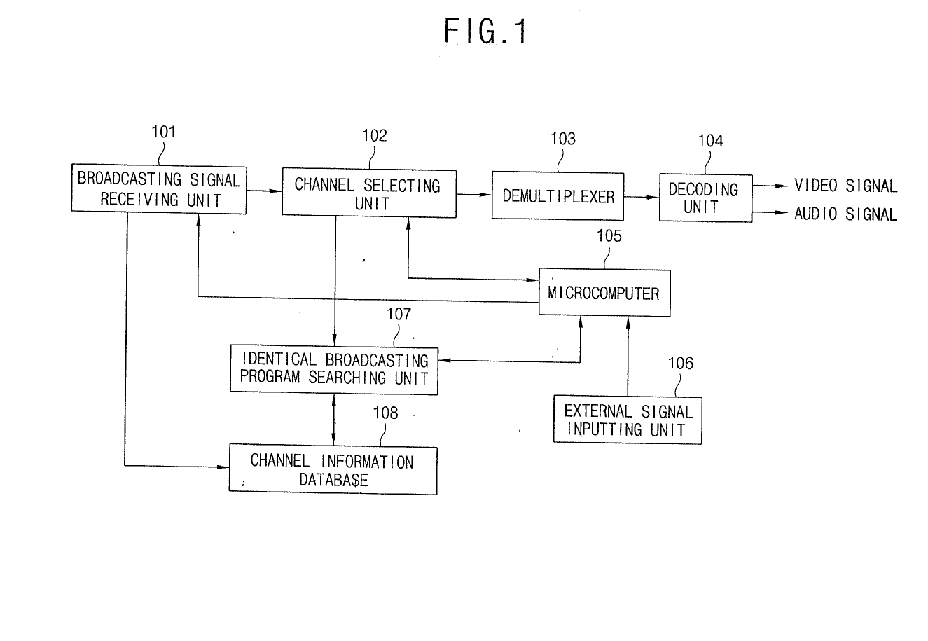

FIG. 1 is a block diagram showing the composition of an apparatus for receiving an identical broadcasting program in accordance with the present invention.

As shown in FIG. 1, the apparatus for receiving the identical broadcasting program comprises a broadcasting signal receiving unit 101 for receiving a broadcasting signal transmitted through multiplex broadcasting media; a channel selection unit 102 for selecting a broadcasting signal selected by a user among the received broadcasting signals or selecting a broadcasting program of a channel to which an identical broadcasting program as a broadcasting program in broadcasting signals corresponding to the channel selected by the user from the multiplex media according to a control signal; a demultiplexer 103 for separating image and voice signals in the broadcasting signals of the channel selected by the user or the channel to which the identical program is received; a decoding unit 104 for outputting the image and voice signals separated by the demultiplexer 103; a channel information database 108 for storing channel information corresponding to the multiplex broadcasting media; an external signal input unit 106 for receiving a channel conversion signal outputted from a remote controller or another input means to receive broadcasting signals which are poor or broadcasting signals having high sound quality or picture quality; an identical broadcasting program searching unit 107 for searching channels to which an identical broadcasting program corresponding to the program of the channel selected by a user is transmitted by comparing the channel selected by the user and the channel information stored in the channel information database according to the channel conversion signal and outputting the searched channel information; and a microcomputer 105 for outputting the control signal for converting the channel selected by the user into the searched channel according to the channel conversion signal. Namely, therefore, the present invention can search a channel to which an identical broadcasting program automatically by pushing a media searching button (not shown) of a remote controller through media which transmit broadcasting signals automatically in case the user wants to watch the identical broadcasting program through the multiplex media from necessity or wants to search broadcasting media to which an identical program with high picture and sound quality is transmitted while the user watches the identical broadcasting program through the media so that the user can watch the identical broadcasting program continuously.

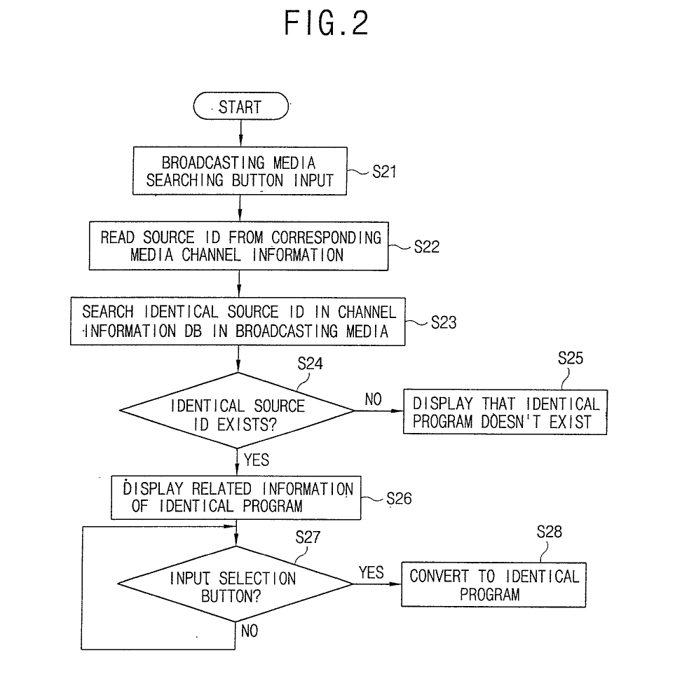

Hereinafter, the operation of the apparatus for receiving the identical broadcasting program through multiplex media in accordance with the present invention will be described in detail with reference to FIG. 2.

FIG. 2 is a flow chart showing the method for receiving the identical broadcasting program in accordance with the present invention.

Firstly, the broadcasting signal receiving unit 101 receives a broadcasting signal transmitted through multiplex broadcasting media and outputs the signal to the channel selection unit 102. Here, the broadcasting signal transmitted through the multiplex media is a broadcasting signal received from ground wave, cable, satellite and the like.

The channel selection unit 102 selects the broadcasting signal selected by the user among the received broadcasting signals or selecting a broadcasting program of the channel to which the identical broadcasting program as a broadcasting program in broadcasting signals corresponding to the channel selected by the user from the multiplex media according to the control signal outputted from the microcomputer 105 and outputs the broadcasting program to the demultiplexer 103.

The demultiplexer 103 separates image and voice signals in the broadcasting signals of the channel selected by the user or the channel to which the identical program is received and outputs the signals to the decoding unit 104.

The decoding unit 104 decodes the image and voice signals separated by the demultiplexer 103 and outputs the video and audio signals.

On the other hand, the external signal input unit 106 receives the channel conversion signal outputted from a remote controller or another input means to receive broadcasting signals which are poor or broadcasting signals having high sound quality or picture quality.

The identical broadcasting program searching unit 107 searches channels to which the identical broadcasting program corresponding to the program of the channel selected by the user is transmitted by comparing the channel selected by the user and the channel information stored in the channel information database according to the channel conversion signal outputted through the microcomputer 105 and outputs the searched channel information to the microcomputer 105. Namely, when the user starts searching by pushing the multiplex broadcasting media searching button (not shown) of a remote control to watch a broadcasting with high picture and sound quality (S21), the identical broadacasting program searching unit 107 reads a source ID of a broadcasting which is currently watched from the channel information of the multiplex media stored in the channel information database 108 (S22) and searches whether there is a broadcasting program having an identical source ID as the source ID by searching the channel information of the multiplex broadcasting media from the channel information database 108 (S23 and S24). Here, the broadcasting program broadcasted through the multiplex broadcasting media has a peculiar source ID and since the channel information of the respective media is composed of the additional information (source ID), the identical program broadcasted in the multiplex broadcasting media can be searched. Also, the source ID is not changed in even in case a digital broadcasting program of a medium is retransmitted to another media.

At this time, if there is no identical broadcasting program, the microcomputer 105 reports this by displaying a message that there is no identical broadcasting program on a monitor (not shown) (S25). On the other hand, if the identical program is searched, the microcomputer 105 displays the related information (media, channel number and the like) on the monitor (not shown) (S26) and if the viewer pushes the selection button (S27), the microcomputer 105 has the viewer receive the broadcasting signal (broadcasting program) immediately by converting channel to the channel of the media using the channel information database of the corresponding media (S28).

Later, the microcomputer 105 outputs the control signal for converting the channel selected by the user into the searched channel according to the channel conversion signal to the channel selection unit 102. The channel selection unit 102 selects a broadcasting program of the channel to which the identical broadcasting program as a broadcasting program in broadcasting signals corresponding to the channel selected by the user from the multiplex media according to the control signal outputted from the microcomputer 105.

As described above, the apparatus and method for receiving the identical broadcasting program has an advantage that the present invention can search the identical broadcasting program which is broadcasted through the multiplex broadcasting media automatically in case the broadcasting signals are not transmitted by a certain reason or the user wants to watch the identical broadcasting program through the multiplex media or wants to search broadcasting media to which an identical program with high picture and sound quality is transmitted while the user watches the broadcasting program through a random medium so that the user can watch the identical broadcasting program continuously.

Also, the apparatus and method for receiving the identical broadcasting program can search the identical program automatically regardless of the number of the channels so that the user can watch the identical program quickly.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A method for receiving an identical broadcasting program comprising the steps of searching and outputting a broadcasting program identical to a multiplex broadcasting program from multiplex broadcasting media on the basis of a source ID of the broadcasting program received from broadcasting media.

2. The method of claim 1, wherein the identical broadcasting program is outputted by searching a broadcasting program having the same source ID as the source ID from the multiplex broadcasting media.

3. The method of claim 1, further comprising the step of:
selecting whether the broadcasting media would be converted by reporting the searched identical broadcasting program to a user.

4. The method of claim 1, wherein the source ID is read from a channel information database.

5. The method of claim 1, further comprising the step of:
displaying a related resultant message to viewers if the identical broadcasting program is not searched from the multiplex broadcasting media.

6. The method of claim 1, further comprising the step of:
displaying related information to viewers if the identical broadcasting program is searched from the multiplex broadcasting media.

7. The method of claim 6, wherein the related information is information about the broadcasting media, that is, numbers of channels to which the identical broadcasting program is transmitted.

8. The method of claim 1, wherein the identical broadcasting program searches broadcasting signals in case the broadcasting signals are poor or the broadcasting signals have high sound quality or picture quality.

9. A method for receiving an identical broadcasting program, comprising:
reading a source ID of a broadcasting program transmitted from broadcasting media;
searching whether the broadcasting program having an identical source ID as the source ID is on the air from multiplex media; and
selecting whether the media would be converted or not by reporting the searching result to the user.

10. The method of claim 9, wherein the source ID is read from a channel information database.

11. The method of claim 9, further comprising the step of:
reporting a searching result if an identical program does not exist after searching the source ID;
displaying information about the broadcasting media and numbers of a channel to which the identical broadcasting program is transmitted if the identical program is searched; and
converting channel to a channel of a media using a channel information database of the corresponding media when the viewer pushes the selection button.

12. An apparatus for receiving an identical broadcasting program, in an apparatus for outputting an image signal or voice signal by receiving broadcasting signal through multiplex broadcasting media, comprising:
an identical broadcasting program searching unit for searching a channel to which a same broadcasting program as a program of a channel selected by a user; and
a channel selection unit for selecting a broadcasting signal corresponding to the searched channel.

13. The apparatus of claim 12, wherein the identical broadcasting program searching unit searches a broadcasting program having a same source ID as a source ID of the broadcasting program from the multiplex broadcasting media.

14. The apparatus of claim 12, wherein the channel selection unit selects the broadcasting signal selected by the user.

15. The apparatus of claim 12, further comprising:
a channel information database for storing channel information corresponding to the multiplex broadcasting media.

16. The apparatus of claim 12, wherein the identical broadcasting program searching unit searches the channels to receive broadcasting signals which are poor or broadcasting signals having high sound quality or picture quality.

17. An apparatus for receiving an identical broadcasting program, comprising:
a channel selection unit for selecting a broadcasting signal of a channel to which an identical broadcasting program corresponding to a broadcasting program selected by a user is transmitted from a multiplex broadcasting media according to a control signal;
a demultiplexer for separating image and voice signals in the selected broadcasting signal;
a decoding unit for decoding and outputting the separated image and voice signals;
a channel information database for storing channel information corresponding to the multiplex broadcasting media;
an identical broadcasting program searching unit for searching channels to which an identical broadcasting program corresponding to the program of the channel selected by a user is transmitted from the multiplex broadcasting media by comparing the channel selected by the user and the channel information stored in the channel information database; and
a microcomputer for outputting the control signal for converting the channel selected by the user into the searched channel.

18. The apparatus of claim 17, wherein the channel selection unit selects the broadcasting program corresponding to the channel selected by the user.

19. The apparatus of claim 17, wherein the identical broadcasting program searching unit searches the identical broadcasting program from the multiplex broadcasting media if a channel conversion signal outputted from a remote controller or another input unit is received.

20. The apparatus of claim 17, wherein the identical broadcasting program searching unit searches the identical broadcasting program to receive broadcasting signals which are poor or broadcasting signals having high sound quality or picture quality.

21. The apparatus of claim 17, wherein the identical broadcasting program searching unit searches a broadcasting program having a same source ID as a source ID from the multiplex broadcasting media.
